(19) United States
(12) Patent Application Publication
(10) Pub. No.: US 2026/0088615 A1
(43) Pub. Date: Mar. 26, 2026

(54) GRID-CONNECTION CONTROL METHOD CONSIDERING SEASONAL TRANSITION FOR THE DUAL-NATURE (FOLLOWING-GRID AND FORMING-GRID) OF RENEWABLE ENERGY TRANSMISSION

(71) Applicant: Kunming University of Science and Technology, Kunming (CN)

(72) Inventors: Hongchun SHU, Kunming (CN); Zongxue SHAO, Kunming (CN); Huaibin GAO, Kunming (CN); Hongfang ZHAO, Kunming (CN); Guangxue WANG, Kunming (CN); Yutao TANG, Kunming (CN); Botao SHI, Kunming (CN)

(73) Assignee: Kunming University of Science and Technology, Kunming (CN)

(21) Appl. No.: 19/062,088

(22) Filed: Feb. 25, 2025

(30) Foreign Application Priority Data
Sep. 26, 2024 (CN) 202411348194.4

(51) Int. Cl. H02J 3/24

(52) U.S. Cl. CPC H02J 3/00142; H02J 2101/20; H02J 2103/30

(57) ABSTRACT

A grid-connection control method considering the duality of grid-following and grid-forming in renewable energy transmission during seasonal transitions includes: obtaining the short-circuit ratio (SCR) at the renewable energy grid connection point; when the SCR is greater than a preset SCR threshold, invoking a grid-following variable coefficient additional frequency control strategy to modulate the PWM inverter for renewable energy grid connection; and when the SCR is less than the preset SCR threshold, invoking a grid-forming variable coefficient virtual synchronous generator (VSG) control strategy to modulate the PWM inverter. The aim is to address the issue of how to combine grid-following and grid-forming control strategies to adapt to changes in grid strength due to seasonal transitions.

### CROSS REFERENCE TO THE RELATED APPLICATIONS

This application is based upon and claims priority to Chinese Patent Application No. 202411348194.4, filed on Sep. 26, 2024, the entire contents of which are incorporated herein by reference.

### TECHNOLOGY FIELD

This application pertains to the field of power system control technology, specifically to a grid-connection control method for renewable energy sources that considers seasonal variations and exhibits grid-following and grid-forming duality.

### BACKGROUND

Following the “dual carbon” strategic objective, the primary development direction of China's energy strategy has shifted towards constructing a new type of power system with renewable energy as the main component. With the continuous increase in the penetration rate of renewable energy, the system's rotational inertia and load-side damping have significantly decreased, leading to prominent issues with frequency stability and regulation in the Yunnan power grid, which is dominated by hydropower.

In related technical solutions, renewable energy inverter control is primarily divided into grid-following control and grid-forming control, each with its own advantages and disadvantages: Grid-following control exhibits current source characteristics externally; with its operating state dependent on the voltage and frequency at the point of common coupling (PCC). It achieves synchronization with the power grid by measuring the phase of the PCC using a phase-locked loop. Grid-forming control, on the other hand, exhibits voltage source characteristics externally, outputting stable voltage and frequency and actively supporting the stability of the power grid's voltage and frequency. However, grid-following control cannot provide voltage and frequency support on its own and must rely on the power grid to provide stable voltage and frequency support for normal operation, making it suitable for strong grid conditions. In contrast, grid-forming control is prone to instability under strong grid conditions and is mainly applicable to weak grid conditions.

Due to the influence of the two seasonal climates in Yunnan—the wet season and the dry season—the strength of the Yunnan power grid varies in different seasons. Therefore, it is necessary to combine grid-following control and grid-forming control strategies to adapt to the changes in grid strength caused by seasonal variations, thereby enhancing the ability and effectiveness of renewable energy sources to participate in primary frequency regulation of the power grid.

The above content is solely intended to assist in understanding the technical solution of this application and does not constitute an acknowledgment that the above content is prior art.

### SUMMARY

The primary objective of this application is to provide a grid-connection control method for renewable energy sources that considers seasonal variations and exhibits grid-following and grid-forming duality, aiming to solve the problem of how to combine grid-following control and grid-forming control strategies to adapt to changes in grid strength caused by seasonal variations.

To achieve the aforementioned objective, this application provides a grid-connection control method for renewable energy sources that considers seasonal variations and exhibits grid-following and grid-forming duality. The method includes:

Obtaining the short-circuit ratio (SCR) at the point of common coupling (PCC) for renewable energy sources.

When the SCR is greater than a preset SCR threshold, a grid-following variable coefficient additional frequency control strategy is invoked to modulate the PWM (Pulse Width Modulation) inverter for renewable energy grid connection.

When the SCR is less than the preset SCR threshold, a grid-forming variable coefficient virtual synchronous generator (VSG) control strategy is invoked to modulate the PWM inverter.

Optionally; the input of the grid type variable coefficient additional frequency strategy includes the frequency difference between the actual measured value of the system frequency of the new energy generation grid connection point and the frequency reference value, the additional power adjustment amount of the grid type control generated by the proportional differential link, the voltage and current at the PCC of the common bus point of the new energy grid connection, the active power reference command, the reactive power reference command and the phase of the PLL output:

The control output of the network-type variable coefficient additional frequency strategy is the required reference instruction of the PWM inverter.

Optionally; the calculation formulas of the additional power regulation of the heeled-mesh control include:

$$Δ P = - {k}_{d} \frac{df}{dt} - {k}_{p} Δ f$$

ΔP is the additional power regulation amount for grid-following control. k_{d} is the derivative coefficient. kₚ is the proportional coefficient. Δf is the frequency change.

Optionally, the selection rules for the derivative coefficient and the proportional coefficient include:

During the stage of frequency deviation from the rated value, larger derivative and proportional coefficients within the stability region are selected as the target derivative coefficient and target proportional coefficient.

During the stage of frequency recovery, smaller derivative and proportional coefficients within the stability region are selected as the target derivative coefficient and target proportional coefficient.

Optionally, the inputs for the grid-forming variable coefficient virtual synchronous generator (VSG) control strategy include: The power difference between the actual measured power and the power reference value at the point of common coupling (PCC) for renewable energy generation. The phase angle required for grid-forming control, generated through virtual inertia coefficient, virtual damping component, and integration component. The voltage and current at the PCC for renewable energy grid connection. The active power reference command. The reactive power reference command. The voltage reference command. The angular frequency reference command:

The control output of the grid-forming variable coefficient VSG control strategy is the reference command required for PWM.

Optionally, the grid-forming variable coefficient VSG control strategy also includes VSG control expressions and droop control expressions, which are formulated as:

$$\{ \begin{matrix}\frac{d ω}{dt} = \frac{1}{Js} ( {D}_{p} ( {ω}_{0} - \frac{d ω}{dt} ) ) + ( {P}_{0} - P ) & ( 1 ) \\ \frac{d ω}{dt} = {ω}_{0} + {k}_{L} ( {P}_{0} - P ) & ( 2 )\end{matrix}$$

Equation (1) represents the VSG control expression, and Equation (2) represents the droop control expression.

Where: J is the virtual inertia coefficient. Dₚ is the virtual damping coefficient. ω is the actual angular frequency of the system. ω₀ is the steady-state angular frequency of the system. P₀ is the steady-state active power of the system. P is the actual active power of the system. k_{L} is the droop coefficient.

Optionally, the selection rules for the virtual inertia coefficient include the following steps:

During the stage of frequency deviation from the rated value, a larger virtual inertia coefficient within the stability region is determined as the target virtual inertia coefficient.

During the stage of frequency recovery, a smaller virtual inertia coefficient within the stability region is determined as the target virtual inertia coefficient.

Optionally, the calculation expression for the short-circuit ratio (SCR) is:

$$SCR = {S}_{ac} / {S}_{n} = \frac{{U}_{ac}^{2}}{\vert {Z}_{eq} \vert {S}_{n}}$$

Where: S_{ac} represents the short-circuit capacity at the point of common coupling (PCC) for renewable energy generation. Sₙ is the rated capacity of the renewable energy equipment. U_{ac} is the busbar voltage magnitude at the PCC for renewable energy generation. Z_{ac} is the equivalent impedance at the PCC for renewable energy generation.

Optionally, the equivalent impedance at the PCC for renewable energy generation is obtained using a fundamental frequency grid impedance identification strategy based on multi-complex filter and recursive discrete Fourier transform (RDFT).

Furthermore, to achieve the aforementioned objectives, the present application also provides a grid frequency regulation system. This grid frequency regulation system includes: a memory, a processor, and a grid-following and grid-forming dual-mode control program for renewable energy generation considering seasonal variations, which is stored on the memory and executable on the processor. When executed by the processor, the grid-following and grid-forming dual-mode control program implements the steps of the grid-following and grid-forming dual-mode control method for renewable energy generation considering seasonal variations as described in any preceding item.

The present application offers at least the following beneficial effects:

By utilizing grid-following variable coefficient additional frequency control, the grid-following control is endowed with frequency support capabilities under strong grid conditions, enhancing the participation of renewable energy in primary frequency regulation through variable coefficients.

Through the application of grid-forming variable coefficient VSG control, the frequency support effect of grid-forming control is improved under weak grid conditions.

By using the short-circuit ratio at the point of common coupling for renewable energy generation as an indicator to measure grid strength, a criterion is provided for smooth switching between grid-following and grid-forming controls, enabling accurate activation of both control modes.

### BRIEF DESCRIPTION OF THE DRAWINGS

FIG. 1 is a schematic diagram of the hardware operating environment architecture of the grid frequency regulation system involved in an embodiment of the present application;

FIG. 2 is a flowchart illustrating the first embodiment of the grid-following and grid-forming dual-mode control method for renewable energy generation considering seasonal variations according to the present application:

FIG. 3 is a block diagram of the grid-following variable coefficient additional frequency control involved in the second embodiment of the present application:

FIG. 4 is a block diagram of the grid-forming variable coefficient Virtual Synchronous Generator (VSG) control involved in the third embodiment of the present application:

FIG. 5 shows the grid frequency simulation result when only the bilateral frequency limit control in LCC-HVDC is engaged is a graph showing the simulation results of grid frequency for the improved grid-following and grid-forming dual-mode control involved in the fourth embodiment of the present application;

The realization of objectives, functional characteristics, and advantages of the present application will be further explained with reference to the embodiments and accompanying drawings.

### DETAILED DESCRIPTION OF THE EMBODIMENTS

To better understand the aforementioned technical solution, the exemplary embodiments of the present disclosure will be described in more detail below with reference to the accompanying drawings. Although exemplary embodiments of the present disclosure are shown in the drawings, it should be understood that the present disclosure can be implemented in various forms and should not be limited by the embodiments described herein. Rather, these embodiments are provided to enable a more thorough understanding of the present disclosure and to fully convey the scope of the present disclosure to those skilled in the art.

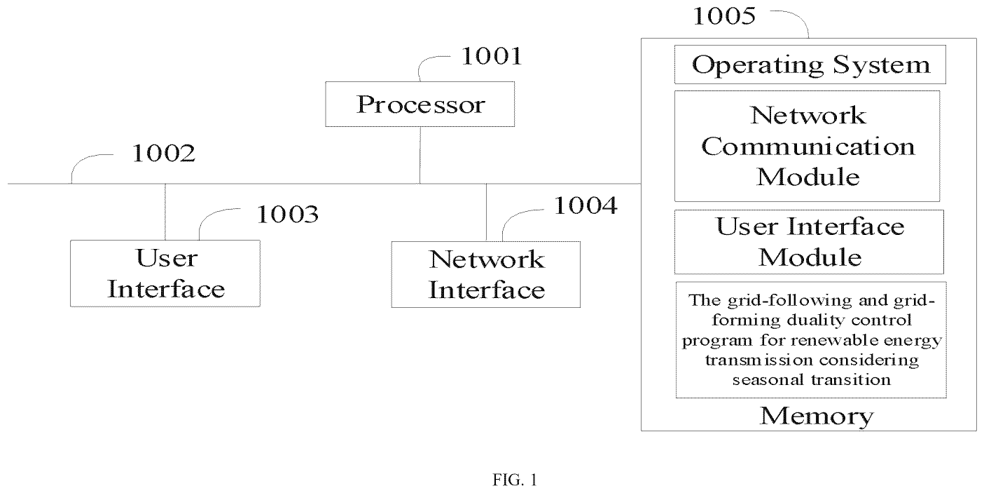

As one implementation scheme, FIG. 1 is a schematic diagram of the hardware operating environment architecture of the grid frequency regulation system involved in an embodiment of the present application.

As shown in FIG. 1, the grid frequency regulation system may include: a processor 1001, such as a CPU, a memory 1005, a user interface 1003, a network interface 1004, and a communication bus 1002. Among them, the communication bus 1002 is used to realize connection communication between these components. The user interface 1003 may include a display screen and an input unit such as a keyboard. Optionally, the user interface 1003 may also include standard wired interfaces and wireless interfaces. The network interface 1004 may optionally include standard wired interfaces and wireless interfaces (such as WI-FI interfaces). The memory 1005 may be a high-speed RAM memory or a stable memory (non-volatile memory), such as a disk memory: Optionally, the memory 1005 may also be a storage device independent of the aforementioned processor 1001.

Those skilled in the art will understand that the grid frequency regulation system architecture shown in FIG. 1 does not constitute a limitation on the grid frequency regulation system and may include more or fewer components than shown in the figure, or may combine some components, or may have different component arrangements.

As shown in FIG. 1, the memory 1005, serving as a storage medium, may include an operating system, a network communication module, a user interface module, and a grid-following and grid-forming dual-mode control program for renewable energy integration considering seasonal variations. Among them, the operating system is a program that manages and controls the hardware and software resources of the grid frequency regulation system, facilitating the operation of the grid-following and grid-forming dual-mode control program for renewable energy integration considering seasonal variations, as well as other software or programs.

In the grid frequency regulation system shown in FIG. 1, the user interface 1003 is primarily used for connecting to terminals and communicating data with them. The network interface 1004 is mainly used for connecting to backend servers and communicating data with them. The processor 1001 can invoke the grid-following and grid-forming dual-mode control program for renewable energy integration considering seasonal variations stored in the memory 1005.

In this embodiment, the grid frequency regulation system includes: a memory 1005, a processor 1001, and a grid-following and grid-forming dual-mode control program for renewable energy integration considering seasonal variations stored on the memory and executable on the processor.

When the processor 1001 invokes the grid-following and grid-forming dual-mode control program for renewable energy integration considering seasonal variations stored in the memory 1005, it performs the following operations:

Obtain the short-circuit ratio (SCR) at the renewable energy grid connection point.

When the SCR is greater than a preset SCR threshold, invoke a grid-following variable coefficient additional frequency control strategy to modulate the PWM (Pulse Width Modulation) inverter for renewable energy grid integration.

When the SCR is less than the preset SCR threshold, invoke a grid-forming variable coefficient Virtual Synchronous Generator (VSG) control strategy to modulate the PWM inverter.

When the processor 1001 invokes the grid-following and grid-forming dual-mode control program for renewable energy integration considering seasonal variations stored in the memory 1005, it performs the following operations:

During the stage of frequency deviation from the rated value, it determines the larger differential coefficient and proportional coefficient within the stability domain as the target differential coefficient and target proportional coefficient, respectively.

During the stage of frequency recovery, it determines the smaller differential coefficient and proportional coefficient within the stability domain as the target differential coefficient and target proportional coefficient, respectively.

Furthermore, during the stage of frequency deviation from the rated value, the processor 1001 also determines the larger virtual inertia coefficient within the stability domain as the target virtual inertia coefficient.

During the stage of frequency recovery, it determines the smaller virtual inertia coefficient within the stability domain as the target virtual inertia coefficient.

Based on the hardware architecture of the grid frequency regulation system utilizing the aforementioned power system control technology; this application proposes an embodiment of the grid-following and grid-forming dual-mode control method for renewable energy integration considering seasonal variations.

### First Embodiment

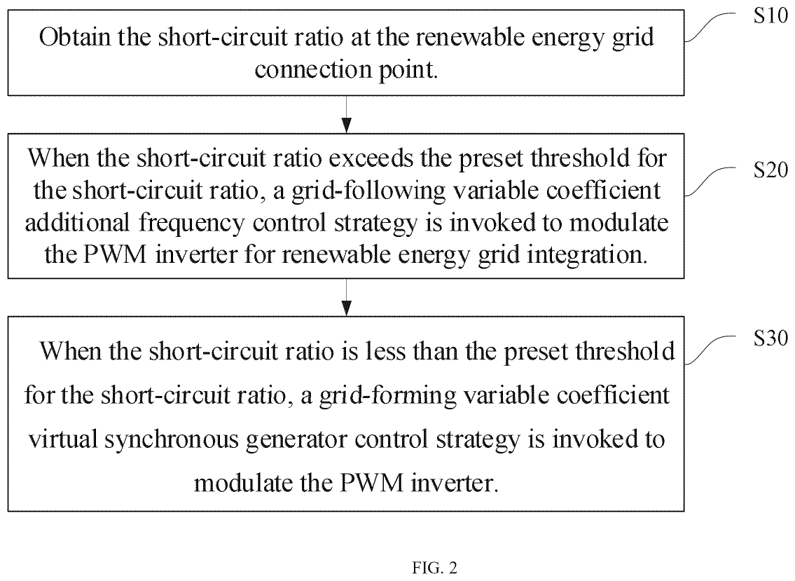

Referring to FIG. 2, in the first embodiment, the grid-following and grid-forming dual-mode control method for renewable energy integration considering seasonal variations includes the following steps:

Step S10: Obtain the short-circuit ratio (SCR) at the renewable energy grid connection point.

Step S20: When the SCR is greater than a preset SCR threshold, invoke the grid-following variable coefficient additional frequency control strategy to modulate the PWM (Pulse Width Modulation) inverter for renewable energy grid integration.

Step S30: When the SCR is less than the preset SCR threshold, invoke the grid-forming variable coefficient Virtual Synchronous Generator (VSG) control strategy to modulate the PWM inverter.

In this embodiment, the grid-following variable coefficient additional frequency control strategy or the grid-forming variable coefficient VSG control strategy is selected based on the SCR at the renewable energy grid connection point.

When the SCR is greater than the preset SCR threshold, it indicates that the grid is under strong grid conditions during the wet season. Utilizing the grid-following variable coefficient additional frequency control enables the grid-following control to provide frequency support under strong grid conditions, enhancing the effectiveness of renewable energy participation in primary frequency regulation through variable coefficients.

When the SCR is less than the preset SCR threshold, it indicates that the grid is under weak grid conditions during the dry season. Utilizing the grid-forming variable coefficient VSG control enhances the frequency support effect of the grid-forming control under weak grid conditions.

Optionally, the formula for calculating the short-circuit ratio (SCR) at the renewable energy grid connection point is as follows:

$$SCR = {S}_{ac} / {S}_{n} = \frac{{U}_{ac}^{2}}{\vert {Z}_{eq} \vert {S}_{n}}$$

In the formula, S_{ac} represents the short-circuit capacity at the renewable energy grid connection point, Sₙ represents the rated capacity of the renewable energy equipment, U_{ac} represents the busbar voltage magnitude at the renewable energy grid connection point, and Z_{eq} represents the equivalent impedance at the renewable energy grid connection point.

Furthermore, the equivalent impedance at the renewable energy grid connection point is obtained using a fundamental frequency grid impedance identification strategy based on a multi-complex filter and a recursive discrete Fourier transform (RDFT).

It should be noted that the purpose of using the fundamental frequency grid impedance identification strategy based on a multi-complex filter and RDFT to calculate the equivalent impedance is to effectively suppress the interference from noise and harmonic components, especially in cases of severe harmonic pollution or numerous interference signals. This can significantly improve the accuracy of fundamental impedance identification. Compared to traditional Fourier transform methods, RDFT reduces redundant calculations and can update impedance values in real-time when grid impedance changes rapidly. The fundamental frequency grid impedance identification strategy can adapt to harmonics and transient signals caused by nonlinear loads in the grid, ensuring accurate identification of equivalent impedance in the grid under various complex operating conditions.

In the technical solution provided by this embodiment, the grid-following variable coefficient additional frequency control strategy or the grid-forming variable coefficient Virtual Synchronous Generator (VSG) control strategy is selected based on the short-circuit ratio at the renewable energy grid connection point. When the short-circuit ratio is greater than the preset short-circuit ratio threshold, it indicates that the grid is under strong grid conditions during the wet season. Utilizing the grid-following variable coefficient additional frequency control enables the grid-following control to provide frequency support under strong grid conditions, enhancing the effectiveness of renewable energy participation in primary frequency regulation through variable coefficients. When the short-circuit ratio is less than the preset short-circuit ratio threshold, it indicates that the grid is under weak grid conditions during the dry season. Utilizing the grid-forming variable coefficient VSG control enhances the frequency support effect of the grid-forming control under weak grid conditions, adapting to changes in grid strength due to seasonal variations and thereby improving the ability and effectiveness of renewable energy participation in grid primary frequency regulation.

### Second Embodiment

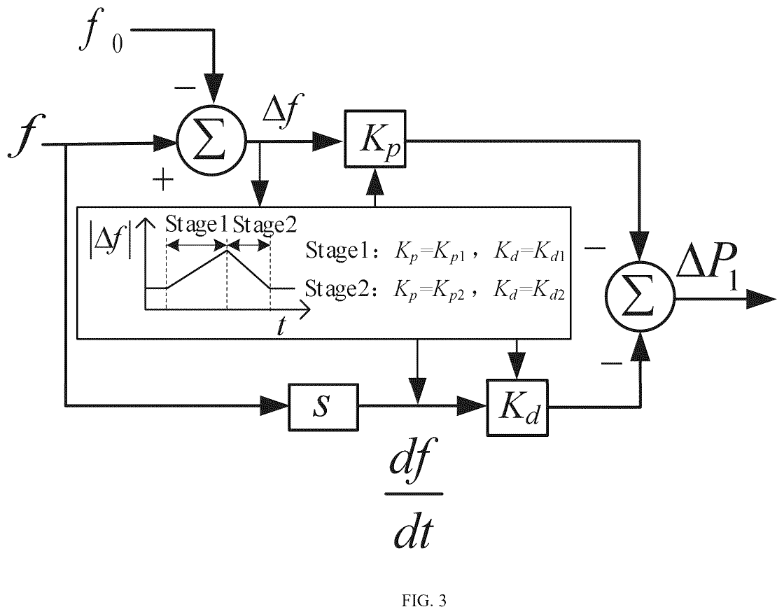

Referring to the block diagram of grid-following variable coefficient additional frequency control shown in FIG. 3, based on the first embodiment, in this embodiment, the input of the grid-following variable coefficient additional frequency control is the difference between the actual measured system frequency f at the renewable energy grid connection point and the frequency reference value f₀. This difference is processed through a proportional-derivative (PD) block to generate the grid-following control additional power adjustment ΔP₁.

The calculation formula for the additional power adjustment ΔP₁ includes:

$$Δ P = - {k}_{d} \frac{df}{dt} - {k}_{p} Δ f$$

In the formula, ΔP represents the grid-following control additional power adjustment, k_{d} represents the derivative coefficient, kₚ represents the proportional coefficient, and Δf represents the frequency variation.

The selection rules for the derivative coefficient ka and the proportional coefficient kₚ include:

The stage of increasing absolute frequency deviation |Δf| is considered as the stage of frequency deviation from the rated value. During this stage, larger derivative and proportional coefficients within the stability domain are selected as the target derivative coefficient kd and target proportional coefficient kp, respectively, to suppress the increase in the absolute frequency deviation.

The stage of decreasing absolute frequency deviation |Δf| is considered as the stage of frequency recovery: During this stage, smaller derivative and proportional coefficients within the stability domain are selected as the target derivative coefficient kd and target proportional coefficient kp, respectively, to accelerate the decrease in the absolute frequency deviation and shorten the frequency recovery time.

Additionally, the inputs of the grid-following variable coefficient additional frequency strategy also include the voltage and current at the Point of Common Coupling (PCC) of the renewable energy grid connection, active power reference commands, reactive power reference commands, and the phase output by the Phase-Locked Loop (PLL).

The control output of the grid-following variable coefficient additional frequency strategy is the reference command required for the Pulse Width Modulation (PWM) inverter.

In the technical solution provided by this embodiment, the grid-following variable coefficient additional frequency control is utilized to enable grid-following control to have frequency support functionality under strong grid conditions, enhancing the effectiveness of renewable energy participation in primary frequency regulation through variable coefficients.

### Third Embodiment

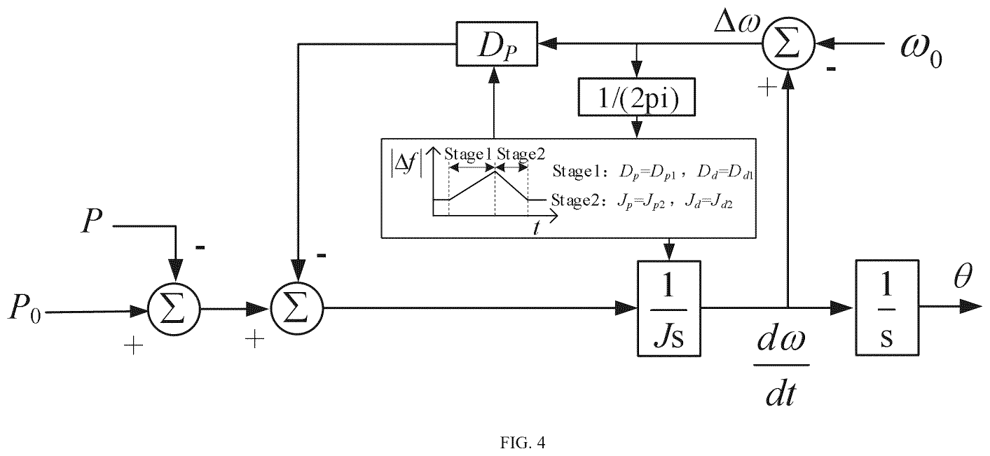

Referring to the block diagram of grid-forming variable coefficient Virtual Synchronous Generator (VSG) control shown in FIG. 4, based on the first embodiment, in this embodiment, the input of the grid-forming variable coefficient VSG control is the frequency difference between the actual measured power P at the renewable energy grid connection point and the power reference value P0. This input is processed through virtual inertia J, virtual damping Dp, and an integration block to generate the phase angle θ required for grid-forming control. The introduction of virtual inertia and virtual damping enables the grid-forming control to have a good frequency support function.

In this embodiment, the grid-forming variable coefficient VSG control strategy also includes VSG control expressions and droop control expressions, which are formulated as:

$$\{ \begin{matrix}\frac{d ω}{dt} = \frac{1}{Js} ( {D}_{p} ( {ω}_{0} - \frac{d ω}{dt} ) ) + ( {P}_{0} - P ) & ( 1 ) \\ \frac{d ω}{dt} = {ω}_{0} + {k}_{L} ( {P}_{0} - P ) & ( 2 )\end{matrix}$$

Equation (1) represents the VSG control expression, and Equation (2) represents the droop control expression.

In these equations, J represents the virtual inertia coefficient, Dₚ represents the virtual damping coefficient, ω represents the actual angular frequency of the system, ω₀ represents the steady-state angular frequency of the system, P₀ represents the steady-state active power of the system, P represents the actual active power of the system, and k_{L} represents the droop coefficient.

Furthermore, the steps for selecting the virtual inertia coefficient include:

Considering the stage of increasing absolute frequency deviation |Δf| as the stage of frequency deviation from the rated value, during this stage, a larger virtual inertia coefficient within the stability domain is selected as the target virtual inertia coefficient to suppress the increase in the absolute frequency deviation.

Considering the stage of decreasing absolute frequency deviation |Δf| as the stage of frequency recovery, during this stage, a smaller virtual inertia coefficient within the stability domain is selected as the target virtual inertia coefficient to enable the frequency to quickly recover to its steady-state value.

Additionally, the inputs of the grid-forming variable coefficient VSG control also include the voltage and current at the Point of Common Coupling (PCC) of the renewable energy grid connection, active power reference commands, reactive power reference commands, voltage reference commands u_{ref}, and angular frequency reference commands ω_{ref}.

The control output of the grid-forming variable coefficient VSG control strategy is the reference command required for Pulse Width Modulation (PWM).

In the technical solution provided by this embodiment, the grid-forming variable coefficient VSG control is utilized to enhance the frequency support effect of grid-forming control under weak grid conditions, adapting to changes in grid strength due to seasonal transitions. This improves the ability and effectiveness of renewable energy participation in primary frequency regulation of the power grid.

### Fourth Embodiment

n this embodiment, to verify the effectiveness of the grid-following and grid-forming duality control method for renewable energy integration considering seasonal transitions proposed in this application, a simulation is conducted where the renewable energy grid-connected system suddenly experiences an increase in load at 20 seconds of operation, causing a power imbalance and a rapid drop in frequency at the renewable energy grid connection point.

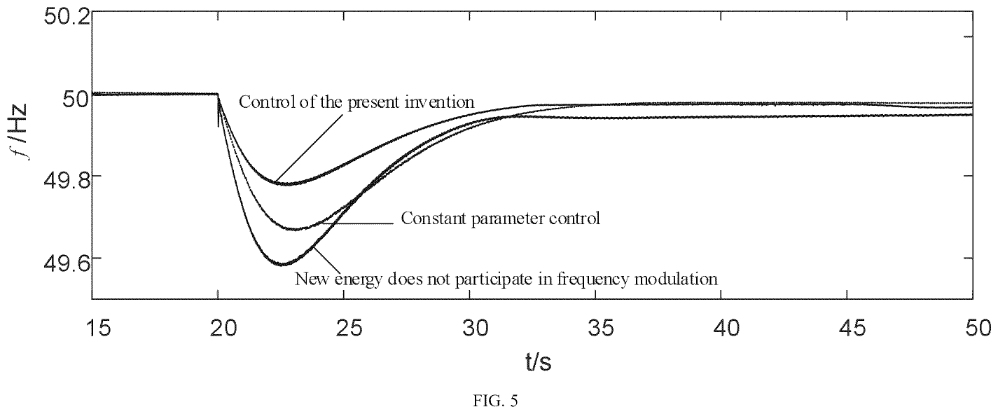

Referring to FIG. 5, which shows the simulation results of grid frequency with improved grid-following and grid-forming duality control, compared to traditional constant parameter control and renewable energy not participating in frequency control, the control technique proposed in this invention results in the smallest frequency drop and the fastest recovery speed at the renewable energy grid connection point.

Furthermore, those skilled in the art can understand that all or part of the processes in the methods of the above embodiments can be instructed by computer programs to complete the relevant hardware tasks. The computer program includes program instructions and can be stored in a storage medium, which is a computer-readable storage medium. The program instructions are executed by at least one processor in the grid frequency regulation system to implement the process steps of the above method embodiments.

Therefore, this application also provides a computer-readable storage medium that stores a renewable energy grid-following and grid-forming duality control program considering seasonal transitions. When executed by a processor, the renewable energy grid-following and grid-forming duality control program implements the steps of the renewable energy grid-following and grid-forming duality control method considering seasonal transitions as described in the above embodiments.

The computer-readable storage medium can be various computer-readable storage media that can store program code, such as USB drives, portable hard drives, Read-Only Memory (ROM). magnetic disks, or optical disks.

It should be noted that since the storage medium provided in the embodiments of this application is used for implementing the method of the embodiments of this application, those skilled in the art can understand the specific structure and variations of the storage medium based on the method introduced in the embodiments of this application, so they are not repeated here. Any storage medium used in the method of the embodiments of this application falls within the scope of protection of this application.

Those skilled in the art should understand that the embodiments of this application can be provided as methods, systems, or computer program products. Therefore, this application can take the form of a completely hardware embodiment, a completely software embodiment, or an embodiment combining software and hardware aspects. Moreover, this application can take the form of a computer program product implemented on one or more computer-usable storage media (including but not limited to magnetic disk storage, CD-ROM, optical memory, etc.) containing computer-usable program code.

This application is described with reference to flowcharts and/or block diagrams of methods, devices (systems), and computer program products according to embodiments of this application. It should be understood that each flow and/or block in the flowcharts and/or block diagrams, and combinations of flows and/or blocks in the flowcharts and/or block diagrams, can be implemented by computer program instructions. These computer program instructions can be provided to a general-purpose computer, a special-purpose computer, an embedded processor, or other programmable data processing devices to produce a machine, such that the instructions, which are executed via the computer or other programmable data processing devices' processors. create means for implementing the functions specified in one or more flows and/or one or more blocks of the flowcharts and/or block diagrams.

These computer program instructions can also be stored in a computer-readable memory that can guide a computer or other programmable data processing devices to work in a specific manner, such that the instructions stored in the computer-readable memory produce an article of manufacture including instruction means that implements the functions specified in one or more flows and/or one or more blocks of the flowcharts and/or block diagrams.

These computer program instructions can also be loaded onto a computer or other programmable data processing devices to cause a series of operational steps to be performed on the computer or other programmable devices to produce computer-implemented processing, so that the instructions executed on the computer or other programmable devices provide steps for implementing the functions specified in one or more flows and/or one or more blocks of the flowcharts and/or block diagrams.

It should be noted that any reference signs located between parentheses in the claims should not be construed as limitations on the claims. The word “including” does not exclude the presence of components or steps not listed in the claims. The use of the word “a” or “one” before a component does not exclude the presence of multiple such components. This application can be implemented with hardware including several different components and with a computer that is appropriately programmed. In unit claims enumerating several devices, several of these devices can be embodied by the same hardware item. The use of words such as first, second, and third does not indicate any order. These words can be interpreted as names.

Although preferred embodiments of this application have been described, those skilled in the art can make additional changes and modifications to these embodiments once they have learned the basic inventive concept. Therefore, the appended claims are intended to be interpreted as including the preferred embodiments and all changes and modifications falling within the scope of this application.

It is apparent that those skilled in the art can make various modifications and variations to this application without departing from the spirit and scope of this application. Thus, if these modifications and variations fall within the scope of the claims and their equivalents of this application, this application is also intended to include these modifications and variations.

What is claimed is:

1. A grid-connection control method considering a duality of grid-following and grid-forming in a renewable energy transmission during seasonal transitions, comprising the following steps:
step 1: obtaining a short-circuit ratio (SCR) at a renewable energy grid connection point:
step 2: when the SCR is greater than a preset SCR threshold, invoking a grid-following variable coefficient additional frequency control strategy to modulate a Pulse Width Modulation (PWM) inverter for a renewable energy grid connection; and
step 3: when the SCR is less than the preset SCR threshold, invoking a grid-forming variable coefficient virtual synchronous generator (VSG) control strategy to modulate the PWM inverter.

2. The grid-connection control method according to claim 1, wherein inputs of the grid-following variable coefficient additional frequency control strategy comprise a frequency difference between an actual measured system frequency at the renewable energy grid connection point and a frequency reference value, an additional power adjustment generated by a proportional-derivative (PD) control loop for a grid-following control, a voltage and a current at a point of common coupling (PCC) for the renewable energy grid connection, an active power reference command, a reactive power reference command, and a phase output by a phase-locked loop (PLL); and
a control output of the grid-following variable coefficient additional frequency control strategy is a required reference command for the PWM inverter.

3. The grid-connection control method according to claim 2, wherein a calculation formula for the additional power adjustment in the grid-following control comprises:
$$Δ P = - {k}_{d} \frac{df}{dt} - {k}_{p} Δ f$$
wherein ΔP represents the additional power adjustment in the grid-following control, k_{d} is a derivative coefficient, kₚ is a proportional coefficient, and Δf is a frequency variation.

4. The grid-connection control method according to claim 3, wherein selection rules for the derivative coefficient and the proportional coefficient comprise:
step 1: during a stage of a frequency deviation from a rated value, determining larger derivative and proportional coefficients within a stability region as a target derivative coefficient and a target proportional coefficient, respectively; and
step 2: during a frequency recovery stage, determining smaller derivative and proportional coefficients within the stability region as the target derivative coefficient and the target proportional coefficient, respectively.

5. The grid-connection control method according to claim 1, wherein inputs of the grid-forming variable coefficient VSG control strategy comprise: a power difference between an actual measured power and a power reference value at the renewable energy grid connection point, a phase angle required for a grid-forming control generated through a virtual inertia coefficient, a virtual damping process and an integration process, a voltage and a current at a PCC for the renewable energy grid connection, an active power reference command, a reactive power reference command, a voltage reference command, and an angular frequency reference command; and
a control output of the grid-forming variable coefficient VSG control strategy is a required reference command for the PWM inverter.

6. The grid-connection control method according to claim 5, wherein the grid-forming variable coefficient VSG control strategy further comprises a VSG control expression and a droop control expression, wherein the VSG control expression and the droop control expression are shown as follows:
$$\{ \begin{matrix}\frac{d ω}{dt} = \frac{1}{Js} ( {D}_{p} ( {ω}_{0} - \frac{d ω}{dt} ) ) + ( {P}_{0} - P ) & ( 1 ) \\ \frac{d ω}{dt} = {ω}_{0} + {k}_{L} ( {P}_{0} - P ) & ( 2 )\end{matrix} ;$$
wherein equation (1) represents the VSG control expression, and equation (2) represents the droop control expression:
wherein J denotes the virtual inertia coefficient, Dₚ represents a virtual damping coefficient, ω stands for an actual angular frequency of a system, ω₀ is a steady-state angular frequency of the system, P₀ is a steady-state active power of the system, P is an actual active power of the system, and k_{L} is a droop coefficient.

7. The grid-connection control method according to claim 6, wherein selection rules for the virtual inertia coefficient comprise the following steps:
step 1: during a stage of a frequency deviation from a rated value, determining a larger virtual inertia coefficient within a stability region as a target virtual inertia coefficient; and
step 2: during a frequency recovery stage, determining a smaller virtual inertia coefficient within the stability region as the target virtual inertia coefficient.

8. The grid-connection control method according to claim 1, wherein a calculation expression for the SCR is:
$$SCR = {S}_{ac} / {S}_{n} = \frac{{U}_{ac}^{2}}{\vert {Z}_{eq} \vert {S}_{n}}$$
wherein S_{ac} represents a short-circuit capacity at the renewable energy grid connection point, Sₙ is a rated capacity of renewable energy equipment, U_{ac} is a busbar voltage magnitude at the renewable energy grid connection point, and Z_{eq} is an equivalent impedance at the renewable energy grid connection point.

9. The grid-connection control method according to claim 8, wherein the equivalent impedance at the renewable energy grid connection point is obtained using a fundamental grid impedance identification strategy based on multi-complex filters and recursive discrete Fourier transform (RDFT).

10. A power grid frequency regulation system, comprising: a memory, a processor, and a grid-following and grid-forming duality control program for the renewable energy transmission considering the seasonal transitions stored on the memory and runnable on the processor: wherein when executed by the processor, the grid-following and grid-forming duality control program for the renewable energy transmission considering the seasonal transitions implements steps of the grid-connection control method according to claim 1.

11. The power grid frequency regulation system according to claim 10, wherein in the grid-connection control method, inputs of the grid-following variable coefficient additional frequency control strategy comprise a frequency difference between an actual measured system frequency at the renewable energy grid connection point and a frequency reference value, an additional power adjustment generated by a PD control loop for a grid-following control, a voltage and a current at a PCC for the renewable energy grid connection, an active power reference command, a reactive power reference command, and a phase output by a PLL; and
a control output of the grid-following variable coefficient additional frequency control strategy is a required reference command for the PWM inverter.

12. The power grid frequency regulation system according to claim 11, wherein in the grid-connection control method, a calculation formula for the additional power adjustment in the grid-following control comprises:
$$Δ P = - {k}_{d} \frac{df}{dt} - {k}_{p} Δ f$$
wherein ΔP represents the additional power adjustment in the grid-following control, k_{d} is a derivative coefficient, kₚ is a proportional coefficient, and Δf is a frequency variation.

13. The power grid frequency regulation system according to claim 12, wherein in the grid-connection control method, selection rules for the derivative coefficient and the proportional coefficient comprise:
step 1: during a stage of a frequency deviation from a rated value, determining larger derivative and proportional coefficients within a stability region as a target derivative coefficient and a target proportional coefficient, respectively; and
step 2: during a frequency recovery stage, determining smaller derivative and proportional coefficients within the stability region as the target derivative coefficient and the target proportional coefficient, respectively.

14. The power grid frequency regulation system according to claim 10, wherein in the grid-connection control method, inputs of the grid-forming variable coefficient VSG control strategy comprise: a power difference between an actual measured power and a power reference value at the renewable energy grid connection point, a phase angle required for a grid-forming control generated through a virtual inertia coefficient, a virtual damping process and an integration process, a voltage and a current at a PCC for the renewable energy grid connection, an active power reference command, a reactive power reference command, a voltage reference command, and an angular frequency reference command; and
a control output of the grid-forming variable coefficient VSG control strategy is a required reference command for the PWM inverter.

15. The power grid frequency regulation system according to claim 14, wherein in the grid-connection control method, the grid-forming variable coefficient VSG control strategy further comprises a VSG control expression and a droop control expression, wherein the VSG control expression and the droop control expression are shown as follows:
$$\{ \begin{matrix}\frac{d ω}{dt} = \frac{1}{Js} ( {D}_{p} ( {ω}_{0} - \frac{d ω}{dt} ) ) + ( {P}_{0} - P ) & ( 1 ) \\ \frac{d ω}{dt} = {ω}_{0} + {k}_{L} ( {P}_{0} - P ) & ( 2 )\end{matrix} ;$$
wherein equation (1) represents the VSG control expression, and equation (2) represents the droop control expression;
wherein J denotes the virtual inertia coefficient, Dₚ represents a virtual damping coefficient, ω stands for an actual angular frequency of a system, ω₀ is a steady-state angular frequency of the system, P₀ is a steady-state active power of the system, P is an actual active power of the system, and k_{L} is a droop coefficient.

16. The power grid frequency regulation system according to claim 15, wherein in the grid-connection control method, selection rules for the virtual inertia coefficient comprise the following steps:
step 1: during a stage of a frequency deviation from a rated value, determining a larger virtual inertia coefficient within a stability region as a target virtual inertia coefficient; and
step 2: during a frequency recovery stage, determining a smaller virtual inertia coefficient within the stability region as the target virtual inertia coefficient.

17. The power grid frequency regulation system according to claim 10, wherein in the grid-connection control method, a calculation expression for the SCR is:
$$SCR = {S}_{ac} / {S}_{n} = \frac{{U}_{ac}^{2}}{\vert {Z}_{eq} \vert {S}_{n}}$$
wherein S_{ac} represents a short-circuit capacity at the renewable energy grid connection point, Sₙ is a rated capacity of renewable energy equipment, U_{ac} is a busbar voltage magnitude at the renewable energy grid connection point, and Z_{eq} is an equivalent impedance at the renewable energy grid connection point.
